(19) United States
(12) Patent Application Publication
(10) Pub. No.: US 2018/0078977 A1
(43) Pub. Date: Mar. 22, 2018

(54) AIR BLOW OFF SYSTEM WITH POWERED ADJUSTABLE AIR DELIVERY DEVICE POSITION

(71) Applicant: ILLINOIS TOOL WORKS INC., Glenview, IL (US)

(72) Inventors: William M. Feldmann, Cincinnati, OH (US); Barbara A. Stefl, Lebanon, OH (US); William R. Immell, Liberty Township, OH (US); Stanley D. Coley, Cincinnati, OH (US)

(21) Appl. No.: 15/705,930

(22) Filed: Sep. 15, 2017

Related U.S. Application Data
(60) Provisional application No. 62/397,403, filed on Sep. 21, 2016.

(51) Int. Cl. B08B 5/02

(52) U.S. Cl. CPC B08B 5/023

(57) ABSTRACT

An air blow off system for use in a line application includes a first air delivery device. The first air delivery device is positioned at a first side of a component travel zone and oriented to blow air toward the component travel zone. A powered actuation assembly is connected for moving the first air delivery device to adjust a spacing of the first air delivery device from the component travel zone.

### CROSS-REFERENCES

This application claims the benefit of U.S. Application Ser. No. 62/397,403, filed Sep. 21, 2016, which is incorporated herein by reference.

### TECHNICAL FIELD

This application relates generally to air delivery devices such as air knives and nozzle manifolds used in blow off applications and, more specifically, to an air blow off system that provides for adjustment of air delivery device position.

### BACKGROUND

Air blow off systems have been used in various line applications for the purpose of blowing off parts or components as part of the production process. Exemplary line applications utilizing such systems include paint lines (e.g., powder coat lines), food and beverage lines (e.g., bottling or other container fill) and automotive lines (e.g., where parts or components are worked). Any time a line is shut down for the purpose of maintenance or adjustment, productivity is impacted.

Accordingly, it would be desirable to provide an air blow off system that is more readily adjustable so as to reduce line down time.

### SUMMARY

In one aspect, an air blow off system for use in a line application includes an air delivery device. The air delivery device is positioned at a first side of a component travel zone and oriented to blow air toward the component travel zone. A powered actuation assembly connected for moving the air delivery device to adjust a spacing of the first air deliver device from the component travel zone.

In another aspect, an air blow off system for use in a line application includes a first air delivery device and a second air delivery device. The first air delivery device is positioned at a first side of a component travel zone and oriented to blow air toward the component travel zone. The second air delivery is positioned at a second side of the component travel zone and oriented to blow air toward the component travel zone. At least one powered actuator is operatively connected to move the first air delivery device and the second air delivery device to adjust a spacing between the first air delivery device and the component travel zone and a spacing between the second air delivery device and the component travel zone.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective view of one embodiment of an air blow off system;

FIG. 2 is a front elevation of the system;

FIG. 3 is a schematic top plan view of the system;

FIGS. 4 and 5 show air delivery device mounts of the system;

FIGS. 6 and 7 show sliding tube mounts of the system;

FIG. 8 shows a perspective view of another embodiment of an air blow off system; and

FIG. 9 shows perspective view of another embodiment of an air blow off system.

### DETAILED DESCRIPTION

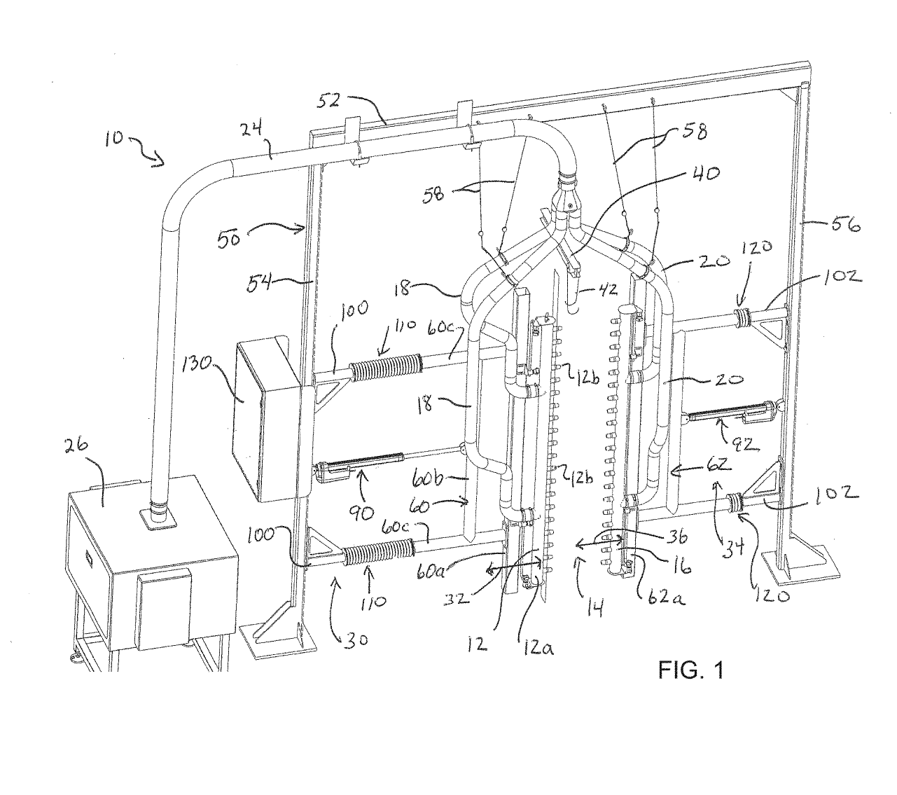

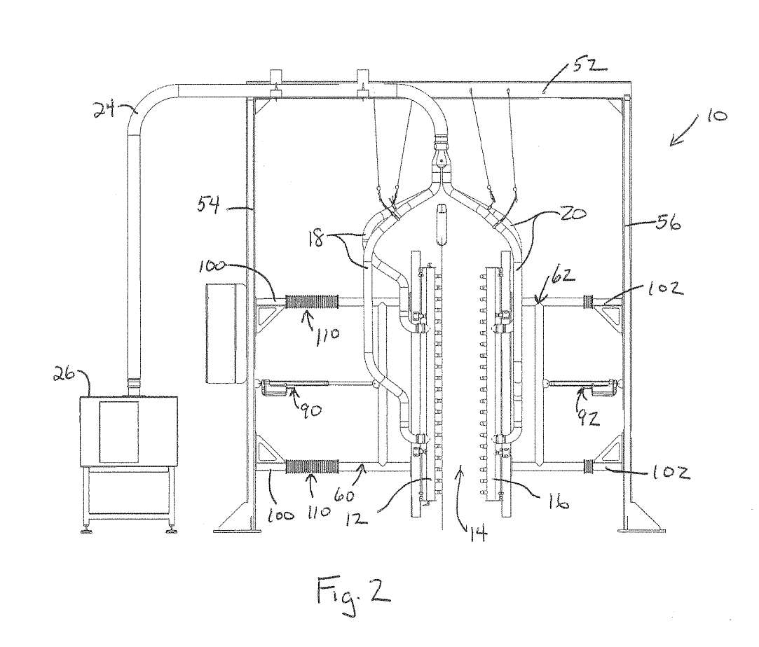

Referring to FIG. 1-2, an exemplary an air blow off system 10 for use in a line application is shown. An air delivery device 12 is positioned at one side of a component travel zone 14 and is oriented to blow air toward the component travel zone 14, while another air delivery device 16 is positioned at an opposite side of the component travel zone 14 and is oriented to blow air toward the component travel zone. In the illustrated embodiment each air delivery device 12 and 16 takes the form of a nozzle manifold (e.g., a tubular manifold 12a with multiple nozzles 12b mounted thereon to eject gaseous fluid), but other air delivery devices, such as air knives, are also contemplated. Here, each air delivery device has a substantially vertical orientation (e.g., nozzles 12b arranged one above the other in a substantially vertical manner), but systems in which the air delivery devices do not have a substantially vertical orientation are also contemplated (e.g., at an angle offset from both vertical and horizontal, or substantially horizontal when arranged at top and bottom sides of the component travel zone).

Each air delivery device is fed by one or more respective tubes or hoses 18 and 20 connected to a common overhead pipe or tube 24, which in turn is connected to a blower unit 26. By way of example, the blower unit may incorporate a high speed centrifugal blower capable of delivering air volumes on the order of 100 CFM to 1500 CFM along the main feed tube 24, but variations on the nature of the blower unit or other source of air, as well as air volume delivery are possible. The air could be any of normal ambient, filtered air, ionized air, or some other gaseous fluid (or mixtures of the same) suitable to the particular blow off application for which the system 10 is to be used, and the term “air” as used herein encompasses all of the foregoing.

A powered actuation assembly 30 is connected for moving the air delivery device 12 closer to or further from the component travel zone 14 (e.g., per travel path 32), and a powered actuation assembly 34 is connected for moving the air delivery device 16 closer to or further from the component travel zone 14 (e.g., per travel path 36). Here, air delivery device 12 is shown in a position at an inward end of its travel path 32 closest to the component travel zone 14, and air delivery device 16 is shown in a position at an outward end of its travel path 36 furthest from the component travel zone 14. In this regard, the two powered actuation assemblies may be linked and operated simultaneously for a common adjustment on both sides of the component travel zone 14 or may not be linked in which case independent adjustment of the two sides would be provided. In either case, in certain embodiments the adjustment may require some user input or action to initiate adjustment while in other embodiments initiation of the adjustment may be fully automated.

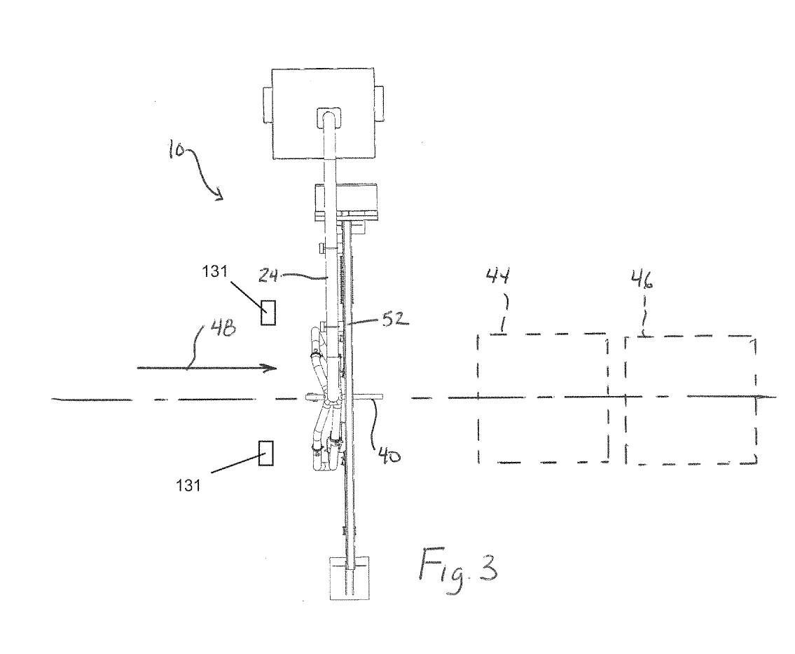

With respect to the component travel zone 14, an upper rail member 40, only a portion of which is shown, includes downward hanging component support hooks 42. This rail system is representative of a line conveyor used for moving components through the blow off system, but other types of line conveyors could also be used. As seen in the schematic top plan depiction of FIG. 3, the air blow off system 10 may represent just a single station of a given line, with subsequent stations 44 and 46 located downstream, where arrow 48 represents the direction of movement of components along the line. Stations of the line could also be located upstream. By way of example, in the case of a powder coat line, stations 44 and 46 could be drying and powder coat stations respectively.

The illustrated blow off system 10 includes a frame 50 with an overhead frame beam 52 and side support beams 54 and 56. In a typical installation the side support beams may be bolted to the floor. Cables 58 run from the beam 52 to each tube 18 and 20 to support the tubes while permitting movement of the tubes as necessary for adjustment of the position of the air delivery devices 12 and 16.

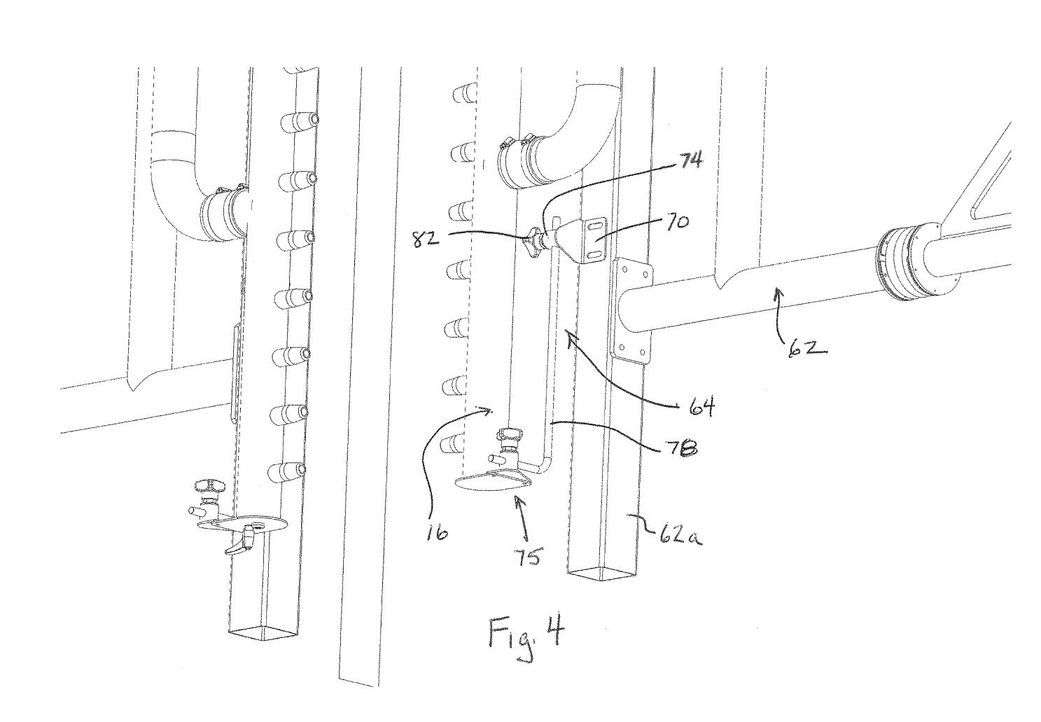

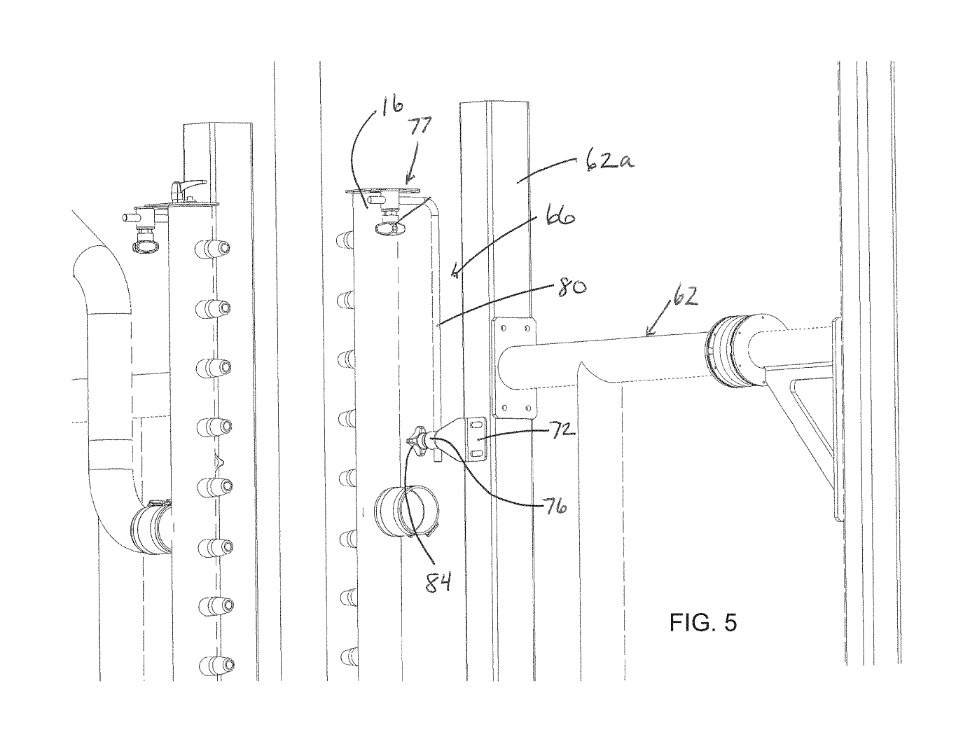

Air delivery device 12 is mounted on and supported by a frame component 60 (by frame segment 60a), and air delivery device 16 is mounted on and supported by a frame component 62 (by frame segment 62a). In this regard, reference is made to FIGS. 4 and 5 showing upper and lower bracket and rod mounts 64 and 66 between the air delivery device 16 and frame component 62. Here, brackets 70, 72 mount to a tube of the frame component 62, and include a rod clamp 74, 76 through which the long leg of an L-shaped rod 78, 80 extends. The rod clamps include rotatable handles 82, 84 that permit manual adjustment of the height of the air delivery device 16 on the frame component 62 (e.g., by loosening the clamps 74, 76, sliding the air delivery device vertically along the rods 78, 80 and then tightening the clamps 74, 76). Similar rod clamps 75 and 77 mount the short leg of the rods to the air delivery device and permit some adjustment of air delivery device position along the direction of component movement.

Referring again to FIGS. 1 and 2, each powered actuation assembly 30, 34 includes a respective powered actuator 90, 92. Actuator 90 is connected to move the frame component 60 and actuator 92 is connected to move the frame component 62. By way of example, actuators 90, 92 may be linear actuators such as stepper motor driven linear actuators. However, other powered actuators could be used, such as hydraulic or pneumatic. The ends of each powered actuator may be pivotally connected (e.g., in the case of actuator 90 one end is pivotally connected to the side support beam 54 and the other end is pivotally connected to the vertical tube 60b of the frame component 60).

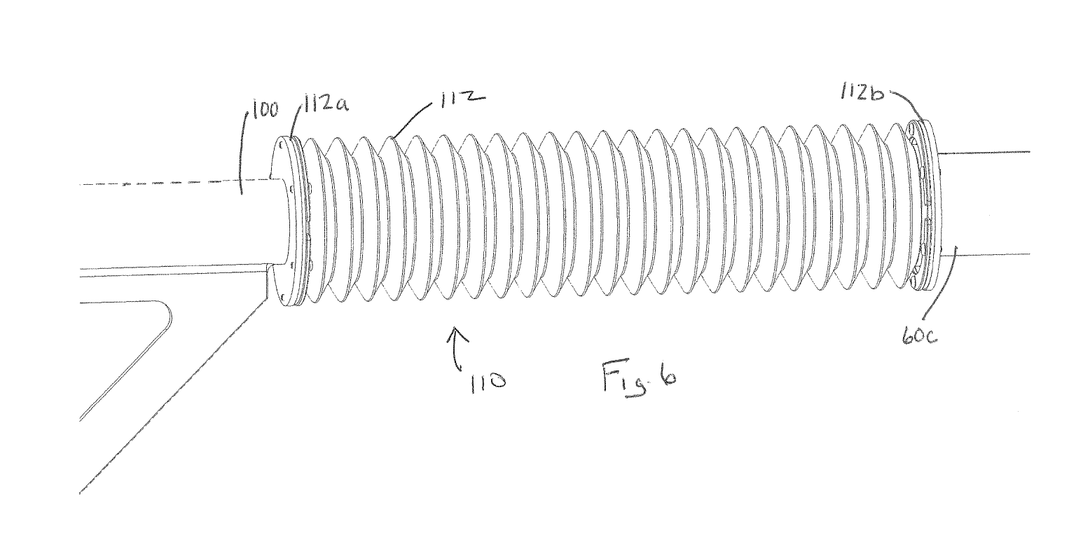

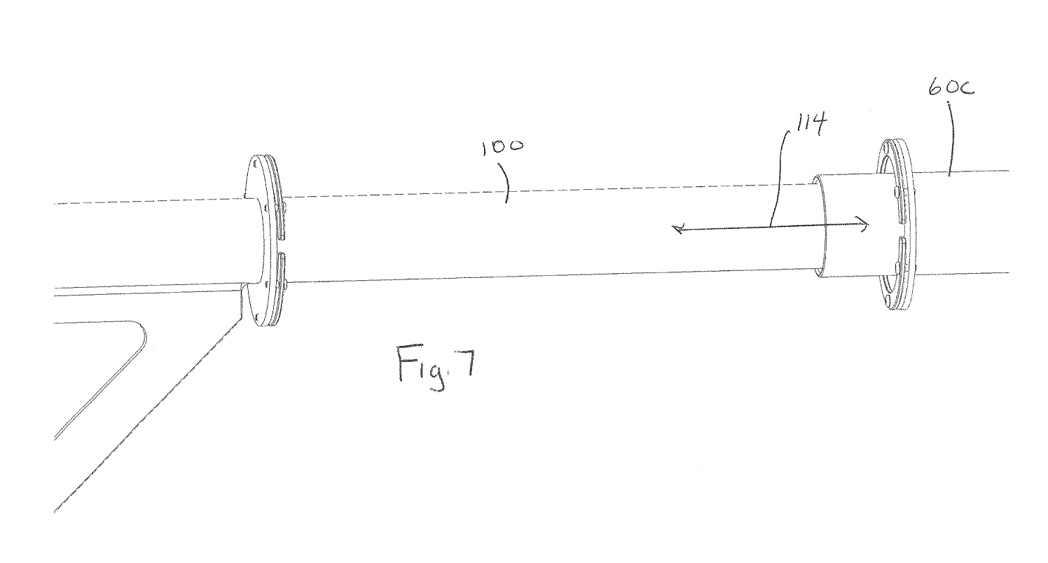

The frame components 60 and 62 are mounted for sliding movement relative to stationary frame parts in the form of side beams 54 and 56 and lateral frame extensions 100 and 102. In the illustrated embodiment, lateral tube members 60c of frame component 60 slidingly engage with the frame extensions 100 via vertically spaced apart sliding tube assemblies 110 (where one tube slides within another tube). As seen in FIGS. 6 and 7, each sliding tube assembly may include a surrounding bellows 112 that is secured to and runs between mount flanges 112a and 112b. Frame extension 100 is positioned within the tubular member 60c of the frame component 60 so that the frame component 60 can slide along the extension during adjustment (e.g., per arrow 114).

Referring again to FIGS. 1 and 2, in the illustrated embodiment the powered actuator 90 is disposed in the vertical space between the upper sliding tube assembly 110 and the lower sliding tube assembly 110, and each of the assemblies 110, as well as the powered actuator 90, are oriented for substantially horizontal movement. Frame component 62 includes similar sliding tube assemblies 120. Although the illustrated tubes have circular cross-sections, it is recognized that tubes with other cross-sections could be used.

From an operational standpoint, a variety of possibilities exist. For example, each powered actuation assembly 30 and 34 may be operable independently of the other to permit for position adjustment of just one air delivery device, or position adjustment of both air delivery devices. Operation of each powered actuation assembly may be triggerable in various ways, including manually by a mechanical user input device (e.g., a button or switch) or manually by an electronic user interface (e.g., a touch screen display). In addition, operation of each powered actuation assembly may be triggered automatically by a controller based upon one or more parameters or conditions, such as a controller based upon component identity (e.g., a controller in control box 130, that is connected to the computerized system operating the line and receives component identity information from the line computer) or a controller based upon feedback from a component sensing system (e.g., a controller in control box 130 in combination with a vision system or other sensor or set of sensors 131 used to detect the identity and/or position of components being moved along the line). In the automated embodiment, the system could provide for real time adjustment of air delivery device position during line operation. As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other components, or a combination of some or all of the above, that carries out the control and/or processing functions of the blow off system or the control and/or processing functions of any component thereof.

Each powered actuation assembly may also include one or more interlocks (e.g., a mechanically, electrically and/or electronically implemented safety or lockout preventing operation of the powered actuators 90, 92 under one or more specific conditions). For example, a controller associated with the powered actuation assemblies may incorporate the interlock feature. By way of example, the specific condition may be one or more of (i) operation of a line conveyor (e.g., to prevent position adjustment of the air delivery devices while the line is running), (ii) operation of a specific line device, (iii) feedback from a sensor, (iv) a user access requirement not being met (e.g., where position adjustment of the air delivery devices is restricted to service personnel or other personnel with secure access) or (v) an actuation limit being reached (e.g., where the controller incorporates an actuation limit that may be tied to the component being carried on the line and/or where limit switches are positioned at desired locations to act as triggers that prevent further movement).

Other variations and configurations are also possible.

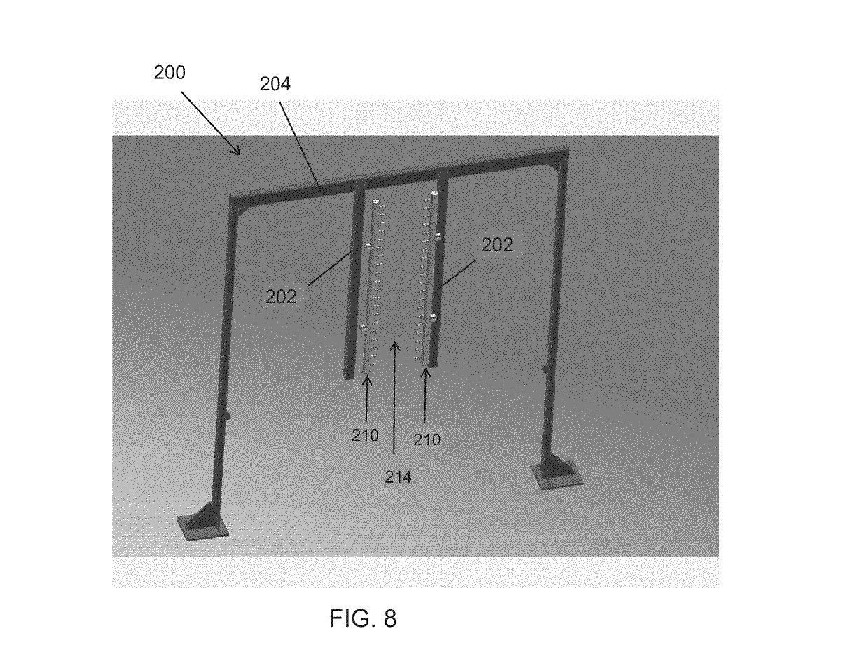

Referring now to FIG. 8, another embodiment of a blow off system 200 is shown in which each air delivery device 210 is supported on a respective substantially vertical beam 202 hanging downward from an overhead frame rail 204. Each beam 202 could be movable laterally toward and/or away from a component travel zone 214 by any of a belt, screw, chain system or other motive device mounted on the rail 204. The same powered actuator (e.g., motor, pneumatic device, hydraulic device) could be used to move both air delivery devices 210, or separate powered actuators could be provided for independent movement of the air delivery devices 210.

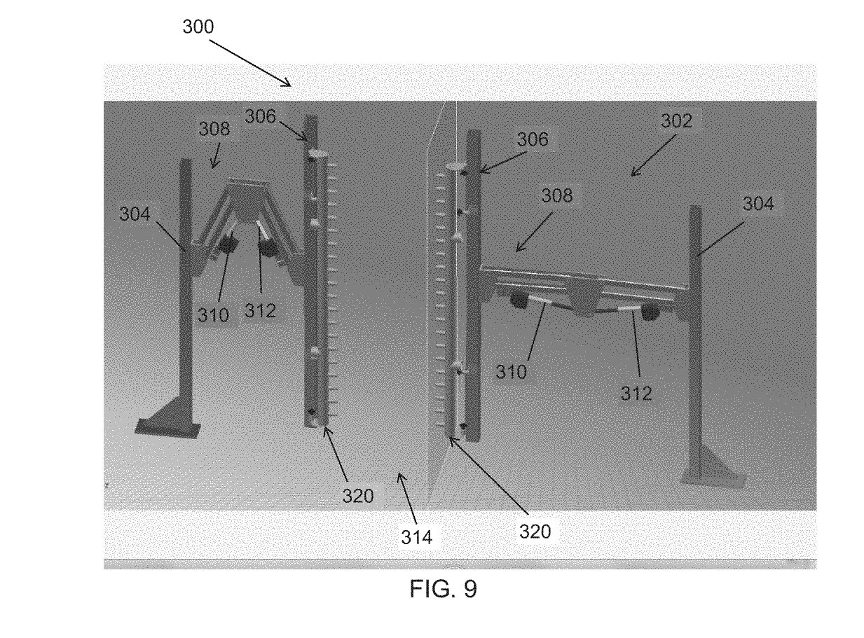

FIG. 9 shows an embodiment of a blow off system 300 in which the frame system 302 includes stationary side beams 304 and moving frame components 306 supporting the air delivery devices 320, where each frame component 306 is mounted for movement relative to its side beam 304 via a linkage system 308 that includes a pair of powered actuators 310 and 312 (e.g., linear actuators). Independent operation of the actuators 310 and 312 of a given side can be used to provide both lateral and vertical position adjustment of the air delivery device 320 of the given side relative to the component travel zone 314, providing for an even more adaptive system. In FIG. 9, the linkage system 308 on the right side of the travel zone 314 is fully extended toward the zone, but the linkage system 308 on the left is retracted to a position further from the zone.

Still other variations are possible. Embodiments in which only a single air delivery device is used are contemplated, as well as embodiments using three or four or more air delivery devices. For example, in a four air delivery device embodiment the devices may be positioned at left, right, top and bottom sides of the component travel zone or conveyance path.

It is to be clearly understood that the above description is intended by way of illustration and example only, is not intended to be taken by way of limitation, and that other changes and modifications are possible.

What is claimed is:

1. An air blow off system for use in a line application, the system comprising:
an air delivery device positioned at one side of a component travel zone and oriented to blow air toward the component travel zone;
a powered actuation assembly connected for moving the air delivery device to adjust a spacing of the air delivery device from the component travel zone.

2. The air blow off system of claim 1, further comprising:
wherein the air delivery device is a first air delivery device;
a second air delivery device is positioned at a second side of the component travel zone and oriented to blow air toward the component travel zone;
wherein the powered actuation assembly is a first powered actuation assembly that is connected for moving the first air delivery device but not the second air delivery device; and
a second powered actuation assembly is connected for moving the second air delivery device to adjust a spacing of the second air delivery device from the component travel zone.

3. The air blow off system of claim 2 wherein the first powered actuation assembly is operable independently of the second powered actuation assembly.

4. The air blow off system of claim 1 wherein operation of the powered actuation assembly is triggerable by at least one of (i) manually by a user triggered device or (ii) automatically by a controller based upon one or more of component identity or feedback from a component sensing system.

5. The air blow off system of claim 1, further comprising:
a controller associated with the powered actuation assembly, the controller including an interlock feature to prevent operation of the powered actuation assembly during at least one specific condition.

6. The air blow off system of claim 5 wherein the specific condition is one of (i) operation of a line conveyor, (ii) operation of a specific line device, (iii) feedback from a sensor, (iv) a user access requirement not being met or (v) an actuation limit being reached.

7. The air blow off system of claim 1, further comprising:
a frame system including a frame component supporting the air delivery device;
wherein the powered actuation assembly includes a powered actuator that is connected to move the frame component.

8. The air blow off system of claim 7:
wherein the frame component is mounted for sliding movement relative to a non-moving frame structure.

9. The air blow off system of claim 8 wherein the frame component and the non-moving frame structure slidingly engage each other via at least one sliding tube assembly.

10. The air blow off system of claim 8 wherein the frame component and the non-moving frame structure slidingly engage each other via first and second sliding tube assemblies, wherein the first sliding tube assembly is vertically spaced apart from the second sliding tube assembly, wherein the powered actuator is disposed in a vertical space between the first sliding tube assembly and the second sliding tube assembly, and each of the first and second sliding tube assemblies and the powered actuator are oriented for substantially horizontal movement.

11. The air blow off system of claim 7 wherein the frame component is supported by an overhead frame rail.

12. The air blow off system of claim 7 wherein the powered actuator is a first powered actuator, the frame component is mounted for movement relative to a non-moving frame structure via a linkage system that includes the first powered actuator and a second powered actuator, the first powered actuator operable independent of the second powered actuator.

13. The air blow off system of claim 1 wherein the powered actuation assembly includes a linear actuator and a position feedback.

14. The air blow off system of claim 1 wherein the powered actuation assembly includes a first powered actuator and a second powered actuator both connected to move the air delivery device, wherein at least one of the first and second powered actuators operates to move the air delivery device at least partly vertically.

15. A processing line including the air blow off system of claim 1, wherein the processing line includes a line conveyor that passes through the component travel zone, wherein the air blow off system forms one processing zone of the processing line and one or more additional processing zones are located upstream and/or downstream of the air blow off system.

16. An air blow off system for use in a line application, the system comprising:
a first air delivery device positioned at a first side of a component travel zone and oriented to blow air toward the component travel zone;
a second air delivery device positioned at a second side of the component travel zone and oriented to blow air toward the component travel zone;
at least one powered actuator operatively connected to move the first air delivery device and the second air delivery device to adjust a spacing between the first air delivery device and the component travel zone and a spacing between the second air delivery device and the component travel zone.

17. The air blow off system of claim 16 wherein a first powered actuator is operatively connected to move the first air delivery device and a second powered actuator is operatively connected to move the second air delivery device.

18. The air blow off system of claim 17 wherein the first powered actuator is operable independently of the second powered actuator.

19. The air blow off system of claim 16 wherein the first air delivery device comprises one of an air knife or a nozzle manifold, and the second air delivery device comprises one of an air knife or a nozzle manifold.

20. The air blow off system of claim 16, further comprising:
a controller associated with the powered actuator, the controller including an interlock feature to prevent operation of the powered actuator during at least one specific condition, wherein the specific condition is one of (i) operation of a line conveyor, (ii) operation of a specific line device, (iii) feedback from a sensor, (iv) a user access requirement not being met or (v) an actuation limit being reached.
